(19) United States
(12) Patent Application Publication
(10) Pub. No.: US 2026/0159155 A1
(43) Pub. Date: Jun. 11, 2026

(54) System Architecture for a Motor Vehicle

(71) Applicant: Robert Bosch GmbH, Stuttgart (DE)

(72) Inventors: Jonas Stueble, Leonberg (DE); Attila Groepler, Stuttgart (DE); Stefan Aust, Mutlangen (DE)

(21) Appl. No.: 19/180,987

(22) Filed: Apr. 16, 2025

(30) Foreign Application Priority Data
Apr. 23, 2024 (DE) 10 2024 203 798.2

(51) Int. Cl. B62D 5/04; B60T 13/74

(52) U.S. Cl. CPC B62D 5/0418; B60T 13/741; B62D 5/0484

(57) ABSTRACT

A system architecture for a motor vehicle includes a steering actuator as well as a brake actuator for each wheel of the motor vehicle. The steering actuator includes a first steering motor and a second steering motor. The system architecture also includes a first control unit system and a second control unit system. The first control unit system is configured to control the first steering motor and at least two first brake actuators. The first brake actuators are assigned wheels of the motor vehicle on two different sides and at least two different axles of the vehicle. The second control unit system is configured to control the second steering motor and at least two second brake actuators. A first brake actuator and a second brake actuator are each arranged on a common axis and on two sides of the motor vehicle.

This application claims priority under 35 U.S.C. § 119 to application no. DE 10 2024 203 798.2, filed on Apr. 23, 2024 in Germany, the disclosure of which is incorporated herein by reference in its entirety.

The disclosure relates to system architectures for motor vehicles, in particular with regard to the arrangement of the individual components and the reliability obtained therefrom,

### BACKGROUND

The system architecture in a motor vehicle relates to the structure and organization of the various electronic components and control systems required for the operation and control of the vehicle. This architecture includes a variety of components including control units, sensors, actuators, and communication interfaces interconnected to enable efficient and reliable control of the vehicle.

An essential part of the system architecture in modern motor vehicles is the control units for steering actuators and brake actuators. These control units are responsible for precisely controlling the steering and brakes of the vehicle and therefore play a critical role in safety, performance, and driving dynamics.

Control units controlling steering actuators are responsible for controlling the steering system of the vehicle. They receive input signals from various sources, for example the steering wheel and/or other vehicle systems, and translate them into corresponding steering movements. To this end, for example, an electric motor is operated that controls the steering movement via a gear rack. Modern vehicles are increasingly using fully electronic steering systems, also referred to as steer-by-wire systems, which refrain from a mechanical connection between steering wheel and wheels.

Brake actuators are responsible for controlling brake systems of the vehicle. The signals from the brake pedal and other vehicle systems are received from a control unit and are implemented into a brake pressure in hydraulic brake systems by controlling a pump. In brake-by-wire systems, a mechanical engagement from the pedal to the brake caliper—usually realized via hydraulics—is omitted. Brake-by-wire technology is generally used for radius-specific brake systems without hydraulic components. The control units for brake actuators also monitor various parameters such as speed, traction, and roadway conditions to adjust the brake force accordingly and to ensure optimal braking performance and stability of the vehicle. Modern brake actuator systems also often include functions such as anti-lock braking systems (ABS), electronic stability control (ESC), and brake force distribution systems (EBD) that help improve safety and travel performance.

In the system architecture of a motor vehicle, the control units for steering actuators and brake actuators typically work closely together to enable precise and coordinated steering and brake control. By integrating various sensors and communication interfaces, these control units can sense and analyze vehicle data in real-time to optimize vehicle performance and ensure a safe and comfortable ride.

A system architecture of a vehicle comprising two control unit units for redundantly designing a steering and braking function is known from publication DE 10 2021 206 184A1. The two control units each control the steering and braking actuators and have a connection to a separate data system. The control units are further connected via a communication interface, wherein the first control unit represents the primary steering control unit (PLS) and the secondary brake control unit (SBS), and wherein the second control unit represents the primary brake control unit (PBS) and the secondary steering control unit (SLS).

A disadvantageous is that the simultaneous connection of the brake actuators to the steering and brake control units generates a weak point in the system with regard to faults in the control connections for brake actuators. For example, an electrical overvoltage in the control connections could interfere with the steering and brake control units at the same time and subsequently interfere with the entire steering brake system.

The disclosure is thus based on the task of proposing a system architecture with a combined steering and braking function with which the above-mentioned disadvantages can be overcome.

The problem is solved according to the disclosure by the subject-matter set forth below.

### SUMMARY

According to a first aspect of the disclosure, this object is achieved by a system architecture for a motor vehicle comprising a steering actuator as well as a brake actuator for each wheel of the motor vehicle. The steering actuator comprises a first steering motor and a second steering motor. The system architecture further comprises a first control unit system and a second control unit system.

A control unit system may comprise a single control unit or a combination of multiple control units for different tasks. In the context of this disclosure, one or more control units are referred to as control unit systems because they have a common task, for example the coordination of steering and braking behavior of the motor vehicle.

The radius-specific brake actuators may be directly supplied with electrical energy and may be embodied as an electromechanical brake.

The first control unit system is configured to control the first steering motor and at least two first brake actuators, wherein the first brake actuators are assigned wheels of the motor vehicle on two different sides and at least two different axles of the vehicle.

The second control unit system is configured to control the second steering motor and at least two second brake actuators, wherein a first brake actuator and a second brake actuator are each arranged on a common axle and on two sides of the motor vehicle.

A motor vehicle within the meaning of this disclosure has two sides, left and right. Moreover, the motor vehicle has a front and a rear. In principle, the disclosure relates to motor vehicles having at least two axles. For example, one control unit system may control the left front and right rear brakes, while the other control unit system controls the right front and left rear brakes.

However, multi-axle motor vehicles may also use the disclosure. In a truck with two rear axles, the control unit systems can control different sides. For example, one control unit system controls front-right, center-left, and rear-right, whereas the other controls the other side. However, for driving safety, it makes sense that each control unit system on each side controls at least one brake actuator, wherein the brake actuators are located on different axles. This prevents the brake actuators of an entire axle from no longer being controlled in the event that one of the control unit systems fails.

The first control unit system and the second control unit system are communicatively connected to each other via logic. The logic may be a common logic that the control unit systems share, or a shared logic, wherein partial logic is assigned to each control unit system. The common logic has the advantage that it is inexpensive. Shared logic requires more components, namely for each control unit system. However, dual logic creates higher reliability.

In any case, the logic should be redundant so that a failure can be compensated for by a corresponding replacement system.

The respective actuators, that is to say the steering actuator and the brake actuators, are preferably pure electromechanical elements, which are designed without electronics and are thus inexpensive to manufacture. Due to the spatial separation of the actuators from the control unit systems, the control unit systems can be arranged further inside the motor vehicle, where they can be better protected from physical impacts. This increases the robustness of the overall system of the motor vehicle, taking into account the redundancy in an accident, because damage to the control units becomes less likely.

Even in the event of a failure of an energy supply or an energy supply port on one of the control unit systems, full functionality is still possible. In the event of a data distribution or vehicle computer failure, full functionality is further enabled by independent data channels. Thus, no single electronic error can affect more than one actuator. This enables a high availability in the event of a fault, which increases the driving safety of the motor vehicle.

In one embodiment, the first control unit system is arranged in a first chamber of a control unit and the second control unit system is arranged in a second chamber of the control unit.

In contrast to the control unit systems, a control unit is a component of the system architecture that houses one or more controllers. The control unit provides an infrastructure for the controller, which comprises, for example, power connections, data buses and/or other electronic components.

In this embodiment, the control unit comprises two chambers each including a control unit system. The chambers protect the control unit systems from damage, in particular physical damage, dirt, fire, water and/or moisture. Dividing the control unit systems into two chambers increases safety because both chambers are unlikely to be damaged at the same time, thus causing both control unit systems to fail at the same time.

As each control unit system controls a steering motor and brake actuators on at least two axles and on each side of the motor vehicle, a minimum control option may be ensured even in the event that one of the control unit systems fails. Even if the possibility of control is limited, a minimum level of driving ability can be maintained with just one control unit system.

In one embodiment, the chambers are separated from each other by a wall.

Higher protection of the control unit systems results from the wall. If the control unit is damaged, the wall can help to prevent damage to the other chamber and thus the control unit system located therein.

In one embodiment, each chamber comprises a hazard sensor.

A hazard sensor is a sensor that can detect a hazard for a control unit system. This may be, for example, a sensor for measuring humidity, temperature, or acceleration. Even more complex sensor systems may be referred to as hazard sensors in the context of this disclosure, for example sensors that may detect physical deformation of the control unit or control unit system. This may comprise, for example, imaging, inductive or electrostatic sensors.

The hazard sensors are capable of detecting a potential hazard for the control unit systems. If such a hazard is detected, it may be indicated via a signal to a moving person, who may then respond to the hazard. For example, the response may include a trip to a workshop or stopping the motor vehicle.

In one embodiment, the control unit systems are arranged in different control units.

The division of the control unit systems into different control units causes each control unit system to have a separate electronic infrastructure. Thus, not only the control unit systems themselves are redundant, but also the associated connections, etc. If a fault arises or exists on one connection, the other control unit system can still be operated without errors.

In one embodiment, the control units are arranged spatially separated from one another in the motor vehicle.

The division into different control units allows for spatial separation of the control unit systems so that simultaneous damage to both control unit systems, in particular physical damage, becomes even less unlikely.

In all embodiments, each control unit system is energetically connected to two independent energy supply units.

An energetic connection is designed so that an energy supply unit can supply the devices coupled via the energy connection with sufficient electrical energy.

The dual availability of energy supply units has the advantage that one of the energy supply units can fail without the need to stop driving immediately. Each energy supply unit can supply energy to both control unit systems, such that at least one restricted travel function of the motor vehicle may be maintained.

In the embodiment with a two chamber control unit, the control unit may be energetically connected to both energy supply units, such that both control unit systems are connected to the energy supply units via these connections.

In the embodiment with two control units, the system architecture has a redundant infrastructure. Each control unit is therefore energetically connected to two energy supply units.

In one embodiment, each energy supply unit comprises a safety mechanism for disconnecting the energetic connection.

For example, the safety mechanism may be in the form of a switch or a fuse.

Preferably, the energy supply units comprise a mechanism for detecting low-resistance connections or short circuits between each other and to vehicle ground. The energy supply units are also coupled to each other via the redundant coupling to the control unit systems. If one energy supply unit were to experience a short circuit, this would also affect the other energy supply unit. In order to prevent this, the energy supply units have safety mechanisms that can disconnect the faulty line or connection point from the on-board power system in the event of a fault. If an energy supply or an energy power supply port on the control unit fails, full functionality can thereby still be enabled.

In one embodiment, each control unit system is communicatively connected to two computing units, wherein the computing units are configured to generate commands for the control unit systems.

The computing units provide the control unit systems with commands, for example, from a central on-board computer or from a moving person via their inputs, the steering wheel and the pedals. The computing units translate the received inputs into instructions, which the control device systems in turn convert into signals for the actuators.

The redundancy of the computing units creates an increased safety for the motor vehicle, as in the event of a failure of one computing unit, the respective other computing unit is configured to supply instructions to both control unit systems.

In one embodiment, the computing units are communicatively connected to each other and configured to adapt the instructions they generate.

Advantageously, in this embodiment, the computing units may communicate directly with each other. Thereby, no unnecessary commands are generated and no command conflict occurs for the control unit systems. Furthermore, the computing units may detect when the respective other computing unit causes an error and fails to respond or respond properly to communication requests.

Advantageously, the communication between the computing units replaces a superordinate central computing unit.

In one embodiment, the system architecture comprises at least one hazard sensor, wherein the control unit systems are configured to control the steering actuator and brake actuators such that the vehicle executes an emergency stop maneuver when the at least one hazard sensor detects a hazard.

In this embodiment, the hazard sensor may be arranged anywhere in the motor vehicle, wherein the hazard sensor is preferably arranged in the vicinity of the systems that are critical for controlling the vehicle. For example, the system architecture may comprise a plurality of hazard sensors, wherein one hazard sensor each is arranged near or directly on the steering actuator and one near or directly on the brake actuators.

This embodiment may further be combined with the above-mentioned embodiment in which the control unit or the control units comprise hazard sensors.

An emergency stop maneuver may include, for example, emergency braking. To the extent that the motor vehicle is equipped with autonomous or semi-autonomous driving functions, the emergency stop maneuver may also comprise the motor vehicle traveling on and stopping on the side strips or towards the roadside. Such a maneuver may also be referred to as a minimum risk maneuver.

In one embodiment, at least two of the brake actuators include a parking brake functionality. Each control unit system is configured to control at least one of the brake actuators with parking brake functionality.

The parking brake function of a motor vehicle ensures that the motor vehicle does not roll away even if the braking system fails. Particularly with hydraulic brake systems, damage to the hydraulics may lead to failure of the brake system.

The fact that each control unit system comprises a brake actuator with parking brake functionality ensures that the vehicle remains safely stationary even if one of the control unit systems is damaged or fails.

In one embodiment, each steering motor includes a rotor position sensor, wherein the control device systems are configured to read the rotor position sensor of the steering motors controlled by them.

The rotor position signal is important for controlling the motors. It is generated by the rotor position sensor directly on the motor shaft and transmitted to the control unit systems that control the respective motor.

In one embodiment, the steering motors act on a common gear rack, wherein the rotor positions sensed with the rotor position sensors are continuously exchanged between the first control unit system and the second control unit system.

In a central steering system, there is also the challenge that both steering motors must act on a common gear rack or motor shaft. The failure of a single rotor position sensor on the steering actuator may be compensated for by continuously exchanging the rotor position information between the control unit systems. Distributing the rotor position signal in real-time is important as the motor control operates in the microsecond range.

The described embodiments and further developments can be combined with one another as desired.

Further possible embodiments, refinements, and implementations of the disclosure also comprise not explicitly mentioned combinations of features of the disclosure described above or below with respect to exemplary embodiments.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

The figures show:

FIG. 1 a first system architecture according to a first embodiment; and

FIG. 2 a first system architecture according to a second embodiment.

### DETAILED DESCRIPTION

In the figures of the drawings, identical reference numerals denote identical or functionally identical elements, parts or components, unless stated otherwise.

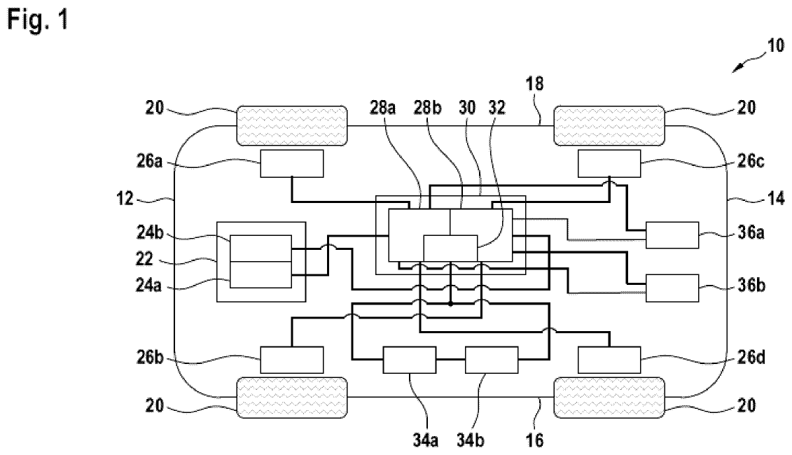

FIG. 1 shows a vehicle 10 having a system architecture in accordance with one embodiment. The vehicle 10 has a front 12 and a rear 14. When viewed in the direction of travel, it has a left side 16 and a right side 18. Accordingly, the vehicle has two axles, each with two wheels 20, one front-left, one front-right, one rear-left, and one rear-right.

The front wheels 20 are steered by a steering actuator 22. To this end, the steering actuator 22 has two steering motors 24a and 24b. The steering motors 24a and 24b engage a gear rack that is connected to the steering rod and can steer the front wheels 20 to the left and the right.

Each of the wheels has a brake actuator 26a, 26b, 26c, and 26d that can be used to individually brake each wheel.

The control of the brake actuators 26a, 26b, 26c, and 26d, as well as steering motors 24a and 24b, are provided by control unit systems 28a and 28b. The control unit systems 28a and 28b may each include a single control unit that controls both steering and braking functions, or may each include multiple control units that control steering and braking functions individually or in groups. For simplicity, one or more control units are referred to as a control device system.

The control unit system 28a is connected to the steering motor 24a, brake actuator 26a on wheel 20 front-right, and brake actuator 26d on wheel 20 rear-left so that it can control them. In the figures, these interconnected elements are marked by a uniform hatching.

The control unit system 28b is connected to the steering motor 24b, brake actuator 26b on wheel 20 front-left, and brake actuator 26c on wheel 20 rear-right to control it.

In an emergency, it is important for the driving stability of the motor vehicle 10 that the brake actuators are activated crosswise, i.e. one brake actuator at the front on one side and one brake actuator at the rear on the other side. If a control unit system were to only control brake actuators on one side or only on one axle, the motor vehicle 10 would only be able to brake on one side in the event of a failure of one control unit system. In the worst case scenario, this would cause the motor vehicle to skid and could lead to tragic accidents.

The control unit systems 28a and 28b are arranged in a control unit 30. The control unit 30 may include a shell for control unit systems 28a and 28b that protects it from damage from physical impact, heat, and/or moisture. Moreover, the control unit 30 may have a partition that divides the shell into two chambers and increases the protection of the control units.

Each chamber is individually protected against hazards such as fire, the ingress of moisture or even water and physical impacts. Dividing into chambers reduces the chance that both control unit systems 28a and 28b will fail simultaneously due to external influence.

In the embodiment illustrated in FIG. 1, control unit systems 28a and 28b share common but redundantly configured logic 32 that controls the control unit systems. The logic 32 in turn receives instructions from two computing units 34a and 34b.

The computing units 34a and 34b are also redundant, so that an error in one of the computing units 34a, 34b can be compensated for by the other or the control of the motor vehicle 10 can be taken over by the remaining computing unit.

The computing units 34a and 34b are also communicatively connected to one another. Via this communicative connection, the computing units 34a and 34b exchange information with each other as to which computing unit is currently generating which instructions. This may avoid command conflicts for control unit systems 28a and 28b. Furthermore, the computing units 34a and 34b may detect from the response of the other computing unit whether a malfunction is present. If this is the case, the remaining computing unit 34a or 34b may initiate appropriate measures, such as generating an alert in the user interface of the motor vehicle 10.

The control unit systems 28a and 28b are supplied with energy by energy supply units 36a and 36b. The energy is required not only for the operation of control unit systems 28a and 28b, but also for the operation or activation of steering motors 24a and 24b, as well as brake actuators 26a, 26b, 26c and 26d.

In the illustrated embodiment, the control unit systems 28a and 28b are supplied with energy via a separate connector. Both control unit systems 28a and 28b are energetically connected to energy supply units 36a and 36b via this port. This also creates redundancy for the energy supply units 36a and 36b, so that if one of the energy supply units 36a or 36b fails, the driving function of the motor vehicle is maintained, although to a limited extent.

If a fault or hazard is detected in the system architecture, for example if one of the computing units 34a, 34b, one of the control unit systems 28a, 28b, or one of the energy supply units 36a, 36b is damaged or defective, the remaining systems can safely bring the motor vehicle 10 to a standstill. If the motor vehicle 10 has autonomous or semi-autonomous driving functions, the computing units 34a and 34b can be configured such that they perform a minimum risk maneuver in the event of damage and bring the motor vehicle 10 to a standstill at the roadside. Furthermore, the brake actuators 26a, 26b, 26c, and/or 26d may be equipped with a parking brake function on at least two wheels 20, which is also activated in the event of damage and secures the motor vehicle 10 from rolling away.

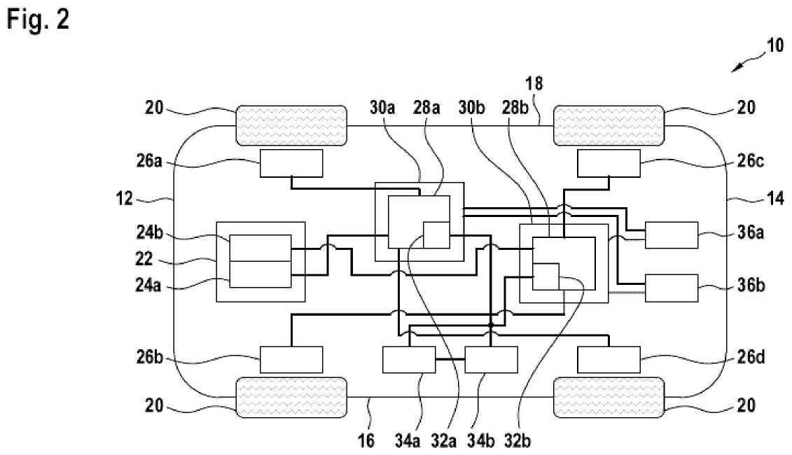

In FIG. 2, an alternative embodiment to FIG. 1 is shown. The system architecture of the motor vehicle 10 in this embodiment comprises two control unit systems 28a and 28b arranged in different control units 30a and 30b. Each control unit 30a and 30b has its own logic 32a and 32b, wherein each of the logic units 32a and 32b is connected to the computing units 34a and 34b.

Moreover, each of the control units 30a, 30b is energetically connected to the energy supply units 36a and 36b.

This system architecture requires the infrastructure for control units 30a and 30b to be provided twice. However, the spatial separation of the control unit 30a and 30b and thus also the control unit systems 28a and 28b reduces the chance that both control units 30a and 30b suffer damage at the same time due to external influences.

If the motor vehicle 10 collides with an obstacle, it is quite possible that individual systems may be damaged and even fail. By physically separating the control unit systems 28a and 28b, the likelihood of both systems being damaged simultaneously from the impact is low. Thus, a minimum level of driving capability of the vehicle 10 can be maintained even in the event of damage to a control unit system 28a, 28b.

What is claimed is:

1. A system architecture for a motor vehicle comprising a steering actuator as well as a brake actuator for each wheel of the motor vehicle, wherein:
the steering actuator comprises a first steering motor and a second steering motor,
the system architecture further comprises a first control unit system and a second control unit system,
the first control unit system is configured to control the first steering motor and at least two first brake actuators, wherein the first brake actuators are assigned wheels of the motor vehicle on two different sides and at least two different axles of the vehicle,
the second control unit system is configured to control the second steering motor and at least two second brake actuators, wherein a first brake actuator and a second brake actuator are each arranged on a common axis and on two sides of the motor vehicle, and
the first control unit system and the second control unit system are communicatively connected to each other via logic.

2. The system architecture according to claim 1, wherein the first control unit system is arranged in a first chamber of a control unit and the second control unit system is arranged in a second chamber of the control unit.

3. The system architecture according to claim 2, wherein each chamber comprises a hazard sensor.

4. The system architecture according to claim 1, wherein the control unit systems are arranged in different control units.

5. The system architecture according to claim 4, wherein the control units are arranged spatially separated from one another in the motor vehicle.

6. The system architecture according to claim 1, wherein each control unit system is energetically connected to two independent energy supply units.

7. The system architecture according to claim 1, wherein each energy supply unit comprises a safety mechanism for separating the energetic connection.

8. The system architecture according to claim 1, wherein each control unit system is communicatively connected to two computing units, and wherein the computing units are configured to generate instructions for the control unit systems.

9. The system architecture according to claim 1, wherein the computing units are communicatively connected to one another, and wherein the computing units are configured to adapt the instructions generated by them to one another.

10. The system architecture according to claim 1, wherein the system architecture comprises at least one hazard sensor, and wherein the control unit systems are configured to control the steering actuator and brake actuators such that the vehicle executes an emergency stop maneuver when the at least one hazard sensor detects a hazard.

11. The system architecture according to claim 1, wherein at least two of the brake actuators comprise a parking brake functionality and wherein each control unit system is configured to control at least one of the brake actuators with parking brake functionality.

12. The system architecture according to claim 1, wherein each steering motor comprises a rotor position sensor, and wherein the control unit systems are configured to read the rotor position sensor of the steering motors controlled by them.

13. The system architecture according to claim 1, wherein the steering motors act on a common gear rack and wherein the rotor positions sensed with the rotor position sensors are continuously exchanged between the first control unit system and the second control unit system.
